(19) United States
(12) Patent Application Publication
(10) Pub. No.: US 2017/0211600 A1
(43) Pub. Date: Jul. 27, 2017

(54) SYSTEM AND METHOD FOR HEATLH MONITORING OF SERVO-HYDRAULIC ACTUATORS

(71) Applicant: Sikorsky Aircraft Corporation, Startford, CT (US)

(72) Inventors: Matthew J. Smith, Rochester, NY (US); Jared Kloda, Warriors Mark, PA (US); Jason Friel, Milwaukee, WI (US); Eric Hettler, Rochester, NY (US)

(21) Appl. No.: 15/300,664

(22) PCT Filed: Apr. 1, 2015
(86) PCT No.: PCT/US2015/023819

§ 371 Date: Sep. 29, 2016

Related U.S. Application Data
(60) Provisional application No. 61/974,025, filed on Apr. 2, 2014.

(51) Int. Cl. F15B 19/00; G01F 25/00; G01M 3/28; G01F 23/00; F15B 20/00; G01M 3/00

(52) U.S. Cl. CPC F15B 19/005; F15B 20/005; G01M 3/002; G01M 3/28; G01F 23/00; G01F 25/0061; F15B 2211/6306; F15B 2211/6343; B64D 2045/0085

(57) ABSTRACT

A method of health monitoring of a hydraulic actuator includes sensing a first hydraulic fluid pressure at a first chamber of a hydraulic cylinder, the first chamber defined by a piston disposed in the cylinder and a first cylinder wall. The method further includes sensing a second hydraulic fluid pressure at a second chamber of the hydraulic cylinder, the second chamber defined by the piston and a second cylinder wall opposite the first cylinder wall. The pressures are summed to derive a pressure sum leakage estimate. An actual piston position in the hydraulic cylinder is determined and compared to an intended piston position to determine a positional error of the piston. A command-response error leakage estimate is derived from the positional error. The pressure sum leakage estimate and the command-response error leakage estimate are fused to determine an internal hydraulic fluid leakage in the hydraulic cylinder.

### CROSS-REFERENCE TO RELATED APPLICATIONS

The present application claims priority to U.S. Provisional Application 61/974,025 filed on Apr. 2, 2014, the contents of which are incorporated by reference herein in their entirely.

### FEDERAL RESEARCH STATEMENT

This invention was made with government support with the U.S. Army under Contract No. W911W6-10-2-0006. The government therefore has certain rights in this invention.

### BACKGROUND

The subject matter disclosed herein generally relates to health monitoring of aircraft. More specifically, the subject disclosure relates to health assessment of hydraulic systems of an aircraft.

A leading driver of maintenance for hydraulic flight control systems is fluid leakage. This includes both external leakage that drains fluid from the stored supply, and internal leakage that reduces component efficiency and degrades system response. Current generation aircraft generally include a Leak Detection and Isolation (LDI) system that is targeted at severe leak conditions that compromise system safety. Generally speaking if the LDI system can observe the leak, enough fluid has been lost that the affected components or system lines need to be isolated by valves and backup systems engaged as required to restore aircraft control. Also, this system provides no information about internal leak conditions that may seriously degrade system performance.

The available information upon which to make decisions about hydraulic component replacement and hydraulic system servicing is currently very limited. The flight control systems on legacy aircraft are not well instrumented and leaks are generally diagnosed by visual inspection and ground check tests. Due to a limited understanding of how leak conditions affect actual system performance, maintenance practice is very conservative and component replacement may be performed before it is needed. With a better understanding of leak size, location and progression, more informed decisions can be made about component service and replacement, maintenance logistics, and hydraulic system servicing.

### BRIEF SUMMARY

In one embodiment, a method of health monitoring of a hydraulic actuator includes sensing a first hydraulic fluid pressure at a first chamber of a hydraulic cylinder, the first chamber defined by a piston disposed in the cylinder and a first cylinder wall. The method further includes sensing a second hydraulic fluid pressure at a second chamber of the hydraulic cylinder, the second chamber defined by the piston and a second cylinder wall opposite the first cylinder wall. The pressures are summed to derive a pressure sum leakage estimate. An actual piston position in the hydraulic cylinder is determined and compared to an intended piston position to determine a positional error of the piston. A command-response error leakage estimate is derived from the positional error. The pressure sum leakage estimate and the command-response error leakage estimate are fused to determine an internal hydraulic fluid leakage in the hydraulic cylinder.

Additionally or alternatively, in this or other embodiments a pressure difference is calculated from the sensed first hydraulic fluid pressure and the second hydraulic fluid pressure, and a hydraulic fluid temperature is detected. The pressure sum leakage estimate and/or the command-response error leakage estimate are compensated based on the pressure difference and/or the hydraulic fluid temperature.

Additionally or alternatively, in this or other embodiments an actuator health indicator is derived from the internal hydraulic fluid leakage.

Additionally or alternatively, in this or other embodiments actuator health indicators of a plurality of actuators are aggregated into a system health indicator.

Additionally or alternatively, in this or other embodiments the internal hydraulic fluid leakage is compared to one or more previously determined internal hydraulic fluid leakages, and a degradation rate is determined based on the comparison.

Additionally or alternatively, in this or other embodiments an actuator health indicator is derived from the internal hydraulic fluid leakage and the degradation rate.

Additionally or alternatively, in this or other embodiments the positional errors of the piston are determined at a same intended piston position.

In another embodiment, a method of health monitoring of a hydraulic actuator includes sensing a first hydraulic fluid pressure at a first chamber of a hydraulic cylinder, the first chamber defined by a piston disposed in the cylinder and a first cylinder wall and sensing a second hydraulic fluid pressure at a second chamber of the hydraulic cylinder, the second chamber defined by the piston and a second cylinder wall opposite the first cylinder wall. The first hydraulic fluid pressure and the second hydraulic fluid pressure are summed to derive a pressure sum leakage, indicative of internal hydraulic fluid leakage in the hydraulic cylinder.

Additionally or alternatively, in this or other embodiments an actual piston position in the hydraulic cylinder is determined. The actual piston position is compared to an intended piston position to determine a positional error of the piston. A command-response error leakage estimate is derived from the positional error and the pressure sum leakage estimate and the command-response error leakage estimate are fused to determine the internal hydraulic fluid leakage in the hydraulic cylinder.

Additionally or alternatively, in this or other embodiments a pressure difference is calculated from the measured first hydraulic fluid pressure and the second hydraulic fluid pressure and a hydraulic fluid temperature is detected. The pressure sum leakage estimate is compensated based on the pressure difference and/or the hydraulic fluid temperature.

Additionally or alternatively, in this or other embodiments an actuator health indicator is derived from the internal hydraulic fluid leakage.

Additionally or alternatively, in this or other embodiments actuator health indicators of a plurality of actuators are aggregated into a system health indicator.

Additionally or alternatively, in this or other embodiments the internal hydraulic fluid leakage is compared to one or more previously determined internal hydraulic fluid leakages, and a degradation rate is determined based on the comparison.

Additionally or alternatively, in this or other embodiments an actuator health indicator is derived from the internal hydraulic fluid leakage and the degradation rate.

In yet another embodiment, a method of health monitoring of a hydraulic actuator includes determining an actual piston position of a piston in a hydraulic cylinder of the hydraulic actuator and comparing the actual piston position to an intended piston position to determine a positional error of the piston. A command-response error leakage estimate is derived from the positional error, indicative of an internal hydraulic fluid leakage in the hydraulic cylinder.

Additionally or alternatively, in this or other embodiments a first hydraulic fluid pressure is sensed at a first chamber of a hydraulic cylinder, the first chamber defined by the piston and a first cylinder wall and a second hydraulic fluid pressure is sensed at a second chamber of the hydraulic cylinder, the second chamber defined by the piston and a second cylinder wall opposite the first cylinder wall. The first hydraulic fluid pressure and the second hydraulic fluid pressure are summed to derive a pressure sum leakage estimate. The pressure sum leakage estimate and the command-response error leakage estimate are fused to determine the internal hydraulic fluid leakage in the hydraulic cylinder.

Additionally or alternatively, in this or other embodiments a pressure difference is calculated from the measured first hydraulic fluid pressure and the second hydraulic fluid pressure, and a hydraulic fluid temperature is detected. The pressure sum leakage estimate and/or the command-response error leakage estimate is compensated based on the pressure difference and/or the hydraulic fluid temperature.

Additionally or alternatively, in this or other embodiments an actuator health indicator is derived from the internal hydraulic fluid leakage.

Additionally or alternatively, in this or other embodiments the internal hydraulic fluid leakage is compared to one or more previously determined internal hydraulic fluid leakages and a degradation rate based on the comparison. An actuator health indicator is derived from the internal hydraulic fluid leakage and the degradation rate.

In still another embodiment, a hydraulic actuator system includes a cylinder and a piston positioned in the cylinder defining a first cylinder chamber and a second cylinder chamber, the piston operably connected to a piston shaft. A leakage detection system is operably connected to the cylinder and includes one or more pressure sensors to detect a first hydraulic fluid pressure in the first chamber and a second hydraulic fluid pressure in the second chamber. The leakage detection system is configured to sum the first hydraulic fluid pressure and the second hydraulic fluid pressure to derive a pressure sum leakage estimate, determine an actual piston position in the hydraulic cylinder, compare the actual piston position to an intended piston position to determine a positional error of the piston, derive a command-response error leakage estimate from the positional error, and fuse the pressure sum leakage estimate and the command-response error leakage estimate to determine an internal hydraulic fluid leakage in the hydraulic cylinder.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an embodiment of an aircraft;

FIG. 2 is an illustration of an embodiment of a hydraulic actuator for an aircraft; and

FIG. 3 is a schematic illustration of a leak detection system for a hydraulic actuator.

The detailed description explains embodiments of the invention, together with advantages and features, by way of example with reference to the drawings.

### DETAILED DESCRIPTION

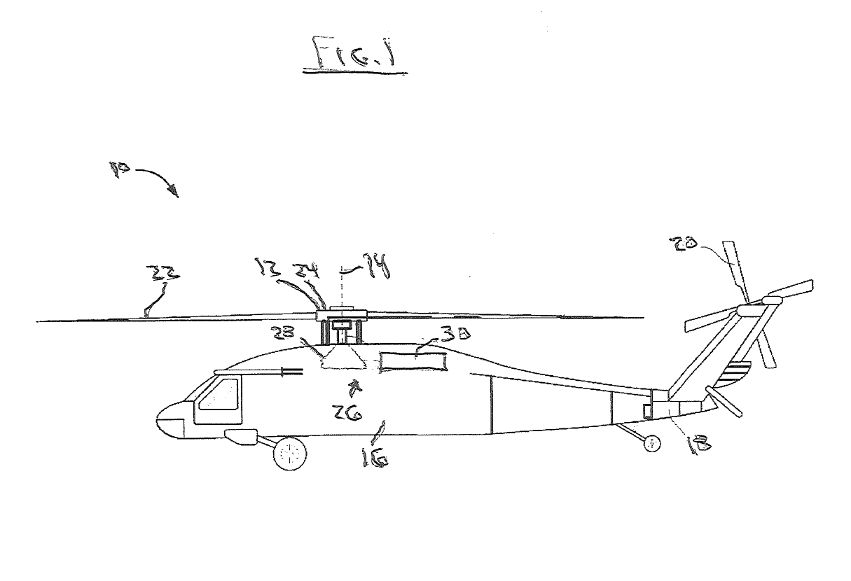

FIG. 1 illustrates an exemplary rotary-winged aircraft 10 having a main rotor system 12, which rotates about a rotor axis 14. The aircraft 10 includes an airframe 16 which supports the main rotor system 12 as well as an extending tail 18 including a tail rotor 20. The main rotor system 12 includes a plurality of rotor blade assemblies 22 mounted to a rotor hub assembly 24. The main rotor system 12 is driven by a transmission 26. The transmission 26 includes a main gearbox 28 driven by one or more engines, illustrated schematically at 30. The main gearbox 28 and engines 30 are considered as part of the non-rotating frame of the aircraft 10. In the case of a rotary wing aircraft, the main gearbox 28 may be interposed between one or more gas turbine engines 30 and the main rotor system 12. Although a particular rotary wing aircraft configuration is illustrated and described in the disclosed non-limiting embodiment, other configurations and/or machines with rotor systems are within the scope of the present invention. Further, one skilled in the art will readily appreciate that the present disclosure may be utilized in other, non-rotary winged aircraft applications. It is to be appreciated that while the description herein relates to a rotary wing aircraft, the disclosure herein may be as readily applied to fixed wing aircraft, ground vehicles, industrial machinery, or other applications that use servo-hydraulic actuators.

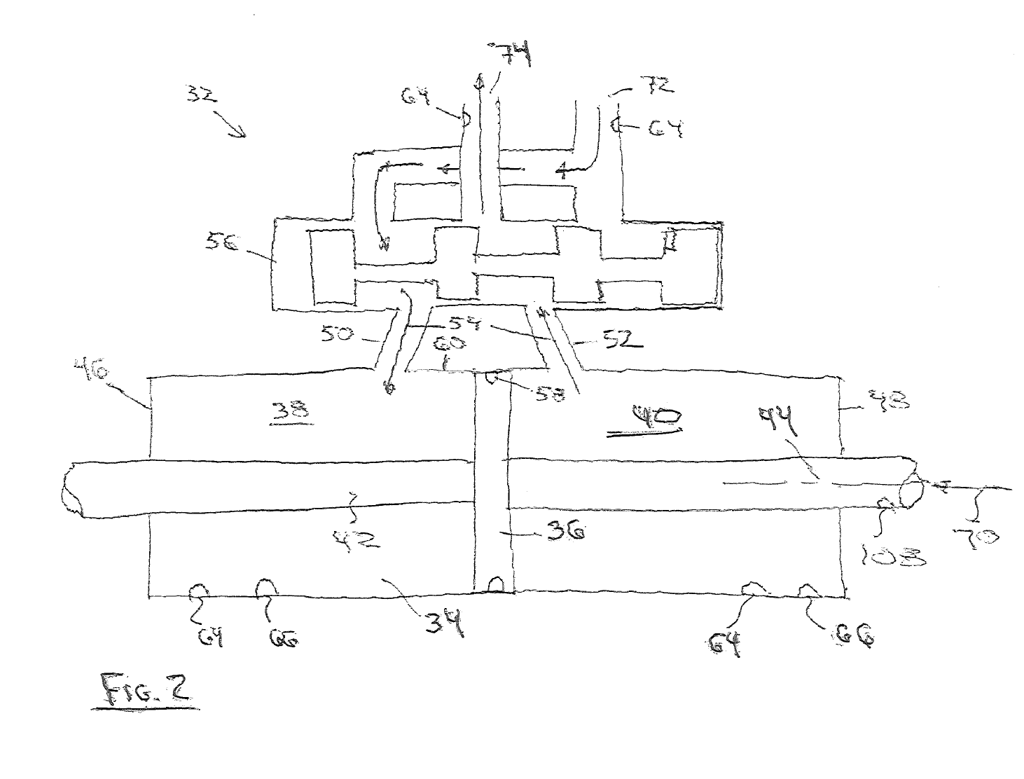

The aircraft 10 may include many systems, such as rotor blade pitch adjustment, ailerons, landing gear and/or other systems, driven by servo-hydraulic actuators 32, an example of which is illustrated in FIG. 2. The actuator 32 includes a cylinder 34 having a piston 36 located in the cylinder 34, which separates the cylinder 34 into a first chamber 38 and a second chamber 40. The piston 36 includes a piston shaft 42 to transmit force outside of the cylinder 34. The piston shaft 42 is connected to a control surface (not shown) of the like, such that movement of the piston shaft 42 along a piston axis 44 effects movement of the control surface. This control surface is under external load 70 from a combination of aerodynamic forces, friction, inertia, and any other system forces. Movement of the piston shaft 42 and the piston 36 is driven by differential fluid pressure between the first chamber 38 and the second chamber 40 when compared to the external actuator load 70. For example, when the force resulting from the differential pressure between the first chamber 38 and the second chamber 40 acting over the surface area of the piston 36 exceeds the total external load 70, the piston 36 is driven from a first chamber wall 46 toward a second chamber wall 48. This continues until the force due to the delta pressure acting on the piston area is balanced with external load 70, effectively enlarging the first chamber 38 and decreasing a volume of the second chamber 40.

The first chamber 38 and the second chamber 40 include first port 50 and second port 52, respectively, which serve as inlet and outlet for hydraulic fluid 54. The flow of hydraulic fluid 54 through the first port 50 and second port 52 is controlled by a servo-valve mechanism 56 operably connected to a hydraulic fluid source (not shown) at supply port 72. Fluid is drained to the hydraulic return through return port 74. The servo-valve mechanism 56 may be electronically controlled or positioned by direct mechanical input.

To maintain the selected fluid pressures in the first chamber 38 and second chamber 40, the piston 36 includes one or more piston seals 58 located at an outer periphery of the piston 36 to seal between the piston 36 and a cylinder wall 60. The piston seals 58 are configured to prevent leakage of hydraulic fluid 54 around the piston between the first chamber 38 and the second chamber 40. Over time, however, the piston seals 58 lose effectiveness through, for example, degradation of or damage to the piston seals 58 or degradation of or damage to the cylinder wall 60. This alters the fluid pressures in the first chamber 38 and the second chamber 40, resulting in reduced performance of the actuator 32, and in some cases failure.

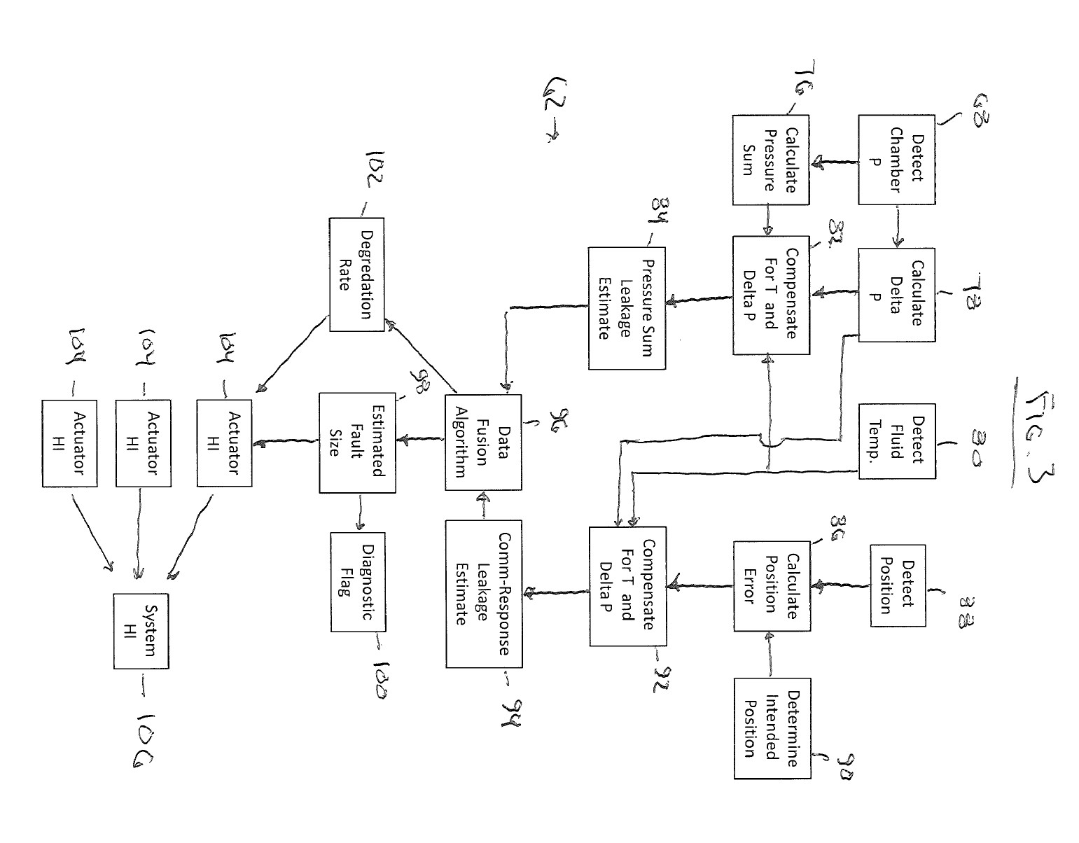

To detect such leakage before failure of the actuator 32, a leak detection system 62, schematically shown in FIG. 3, is utilized. Pressure sensors 66 (shown in FIG. 2) detect hydraulic fluid 54 pressure at the first chamber 38 and the second chamber 40 in block 68. These pressures are combined to calculate a pressure sum in 76, and are differenced to provide a delta pressure at block 78. A hydraulic fluid temperature is detected by one or more temperature sensors 64 that may be located in various locations in the actuator 32, for example, in either chamber 38, 40 or in the servo supply line 72 or return line 74. The calculated delta pressure 78 and fluid temperature measurement 80 are utilized in combination with a model to perform temperature and load compensation at block 82 and produce a leak size estimate that is independent of these factors at block 84.

A position comparison is performed between a piston actual position 88 derived from, for example, a position sensor 108, and a piston intended position 90 derived from the servo mechanism 56, fly-by-wire device or other actuator controller. The result of the position comparison is a positional error 86 and is indicative of piston seal 58 leakage, where a relatively small positional error 86 indicates little or no leakage and a relatively large positional error 86 indicates a greater amount of leakage. The position error 86 is also influenced by the operating temperature and external load. A model 92 is used to compensate for these effects using observations of the delta pressure 78 and the fluid temperature 80, resulting in a corrected command-response leakage estimate 94.

A weighted data fusion process 96 combines the multiple leak estimates 84, 94 into a single estimated fault size 98 and, when appropriate, triggers a diagnostic flag 100 indicating maintenance attention is needed. The estimated fault size 98 can represent, for example, internal hydraulic fluid leakage. To track the progression of leakage over time, pressure sum and command response error changes may be compared to previously determined values at the data fusion algorithm 96 to arrive at a degradation rate 102. The past and current observations of compensated pressure sum 84 and the command-response leakage estimate 94 are combined with the degradation rate 102 information using weight factors that give priority to either approach based upon defined confidence metrics for the respective approaches for various leak sizes and operating conditions. The fused assessment of internal leakage is used to derive a health indicator 104, which in some embodiments is rolled up into a formulation of an aircraft or system health indicator 106, including actuator health indicators 104 from other actuators 32 in the system or other hydraulic components like pumps, valves, or fluid lines.

It should be noted that while the above description is presented such that both the pressure sum leak estimate 84 and command response leak estimates 94 are calculated, the approach is also valid in cases in which the system configuration and available data sources allow for implementation of only one of these parallel methods. In such a case the estimated fault size 98 and actuator health index 104 would be based solely upon the leakage estimate from the single approach.

Use of the above described system and method allows for quick isolation of performance issues to specific actuators 32 without the need for complex and time consuming analysis. The leakage information, through the health indicator is available in real-time.

Further, the system and method allow for problems to be addressed proactively, prior to failure of the actuator and/or before the leakage has a detrimental effect on system performance. Finally, this capability reduces the chance for aircraft maintainers to replace a healthy component before it is required by actual condition, thereby reducing the costs of unnecessary maintenance operations.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of health monitoring of a hydraulic actuator comprising:
sensing a first hydraulic fluid pressure at a first chamber of a hydraulic cylinder, the first chamber defined by a piston disposed in the cylinder and a first cylinder wall;
sensing a second hydraulic fluid pressure at a second chamber of the hydraulic cylinder, the second chamber defined by the piston and a second cylinder wall opposite the first cylinder wall;
summing these pressures to derive a pressure sum leakage estimate;
determining an actual piston position in the hydraulic cylinder;
comparing the actual piston position to an intended piston position to determine a positional error of the piston;
deriving a command-response error leakage estimate from the positional error; and
fusing the pressure sum leakage estimate and the command-response error leakage estimate to determine an internal hydraulic fluid leakage in the hydraulic cylinder.

2. The method of claim 1, further comprising:
calculating a pressure difference from the sensed first hydraulic fluid pressure and the second hydraulic fluid pressure;
detecting a hydraulic fluid temperature; and
compensating the pressure sum leakage estimate and/or the command-response error leakage estimate based on the pressure difference and/or the hydraulic fluid temperature.

3. The method of claim 1, further comprising deriving an actuator health indicator from the internal hydraulic fluid leakage.

4. The method of claim 3, further comprising aggregating actuator health indicators of a plurality of actuators into a system health indicator.

5. The method of claim 1, further comprising:
comparing the internal hydraulic fluid leakage to one or more previously determined internal hydraulic fluid leakages; and
determining a degradation rate based on the comparison.

6. The method of claim 5, further comprising deriving an actuator health indicator from the internal hydraulic fluid leakage and the degradation rate.

7. The method of claim 1, wherein the positional errors of the piston are determined at a same intended piston position.

8. A method of health monitoring of a hydraulic actuator comprising:
sensing a first hydraulic fluid pressure at a first chamber of a hydraulic cylinder, the first chamber defined by a piston disposed in the cylinder and a first cylinder wall;
sensing a second hydraulic fluid pressure at a second chamber of the hydraulic cylinder, the second chamber defined by the piston and a second cylinder wall opposite the first cylinder wall;
summing the first hydraulic fluid pressure and the second hydraulic fluid pressure to derive a pressure sum leakage, indicative of internal hydraulic fluid leakage in the hydraulic cylinder.

9. The method of claim 8, further comprising:
determining an actual piston position in the hydraulic cylinder;
comparing the actual piston position to an intended piston position to determine a positional error of the piston;
deriving a command-response error leakage estimate from the positional error; and
fusing the pressure sum leakage estimate and the command-response error leakage estimate to determine the internal hydraulic fluid leakage in the hydraulic cylinder.

10. The method of claim 8, further comprising:
calculating a pressure difference from the measured first hydraulic fluid pressure and the second hydraulic fluid pressure;
detecting a hydraulic fluid temperature; and
compensating the pressure sum leakage estimate based on the pressure difference and/or the hydraulic fluid temperature.

11. The method of claim 8, further comprising deriving an actuator health indicator from the internal hydraulic fluid leakage.

12. The method of claim 11, further comprising aggregating actuator health indicators of a plurality of actuators into a system health indicator.

13. The method of claim 8, further comprising:
comparing the internal hydraulic fluid leakage to one or more previously determined internal hydraulic fluid leakages; and
determining a degradation rate based on the comparison.

14. The method of claim 13, further comprising deriving an actuator health indicator from the internal hydraulic fluid leakage and the degradation rate.

15. A method of health monitoring of a hydraulic actuator comprising:
determining an actual piston position of a piston in a hydraulic cylinder of the hydraulic actuator;
comparing the actual piston position to an intended piston position to determine a positional error of the piston; and
deriving a command-response error leakage estimate from the positional error, indicative of an internal hydraulic fluid leakage in the hydraulic cylinder.

16. The method of claim 15, further comprising:
sensing a first hydraulic fluid pressure at a first chamber of a hydraulic cylinder, the first chamber defined by the piston and a first cylinder wall;
sensing a second hydraulic fluid pressure at a second chamber of the hydraulic cylinder, the second chamber defined by the piston and a second cylinder wall opposite the first cylinder wall;
summing the first hydraulic fluid pressure and the second hydraulic fluid pressure to derive a pressure sum leakage estimate; and
fusing the pressure sum leakage estimate and the command-response error leakage estimate to determine the internal hydraulic fluid leakage in the hydraulic cylinder.

17. The method of claim 16, further comprising:
calculating a pressure difference from the measured first hydraulic fluid pressure and the second hydraulic fluid pressure;
detecting a hydraulic fluid temperature; and
compensating the pressure sum leakage estimate and/or the command-response error leakage estimate based on the pressure difference and/or the hydraulic fluid temperature.

18. The method of claim 15, further comprising deriving an actuator health indicator from the internal hydraulic fluid leakage.

19. The method of claim 15, further comprising:
comparing the internal hydraulic fluid leakage to one or more previously determined internal hydraulic fluid leakages;
determining a degradation rate based on the comparison; and
deriving an actuator health indicator from the internal hydraulic fluid leakage and the degradation rate.

20. A hydraulic actuator system comprising:
a cylinder;
a piston disposed in the cylinder defining a first cylinder chamber and a second cylinder chamber, the piston operably connected to a piston shaft; and
a leakage detection system operably connected to the cylinder including one or more pressure sensors to detect a first hydraulic fluid pressure in the first chamber and a second hydraulic fluid pressure in the second chamber, the leakage detection system configured to:
sum the first hydraulic fluid pressure and the second hydraulic fluid pressure to derive a pressure sum leakage estimate;
determine an actual piston position in the hydraulic cylinder;
compare the actual piston position to an intended piston position to determine a positional error of the piston;
derive a command-response error leakage estimate from the positional error; and
fuse the pressure sum leakage estimate and the command-response error leakage estimate to determine an internal hydraulic fluid leakage in the hydraulic cylinder.
